(19) United States
(12) Patent Application Publication
(10) Pub. No.: US 2009/0135274 A1
(43) Pub. Date: May 28, 2009

(54) System and method for inserting position information into image

(75) Inventors: Won-jung Kim, Changwon-city (KR); Sung-ha Park, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/313,254

(22) Filed: Nov. 18, 2008

(30) Foreign Application Priority Data
Nov. 23, 2007 (KR) 10-2007-0120341

(51) Int. Cl. H04N 5/76; G01C 21/00

(52) U.S. Cl. 348/231.5; 701/213; 348/E05.001

(57) ABSTRACT

A system for connecting a global positioning system (GPS) device to a digital image processing device and inserting position information into an image file created by the digital image processing device, and a method of operating the system are provided. The system comprises a digital image processing device for capturing an image, generating and storing a plurality of image files; and a GPS device for computing a position based on data received from a GPS satellite, wherein, the GPS device comprises a GPS information storage unit for storing inherent information an image file and position information of a position at which the image is captured when a predetermined image capture signal is received from the digital image processing device; and wherein the digital image processing device comprises a GPS information input controller for inserting position information of the position at which the image is captured into the image file.

### CROSS-REFERENCE TO RELATED PATENT APPLICATIONS

This application claims the benefit of Korean Patent Application No. 10-2007-0120341, filed on Nov. 23, 2007, in the Korean Intellectual Property Office, the disclosure of which is incorporated herein in its entirety by reference.

### BACKGROUND

1. Field of the Invention

The present invention relates to a system for connecting a global positioning system (GPS) device to a digital image processing device and inserting position information into an image file created by the digital image processing device, and a and method of operating the system.

2. Description of the Related Art

Recently, various types of digital image processing devices, which capture images and store them in digital form, have been produced. Examples of these digital image processing devices include digital cameras, camcorders, mobile phones having a camera installed therein, electronic organizers having a camera installed therein, and personal data assistants (PDAs). These digital image processing devices can be carried while traveling or mountain climbing and may be used to capture and electronically record images of various scenes. However, even though conventional digital image processing devices support photographing, image storing, and image searching, they do not allow storage of information about a place where an image is captured or information about characteristics of the place.

In order to address this problem, a global positioning system (GPS) is installed in a digital image processing device so that information about a place where an image is captured or information about characteristics of the place can be stored.

Communication information may be transmitted between a GPS receiver and an image capturing terminal to add position information to an image. The GPS receiver may have a wireless communication function and a GPS function. The image capturing terminal may have an image capturing function and a function of wirelessly communicating with the GPS receiver. The GPS receiver and the image capturing terminal may perform point-to-point wireless communication and exchange information via serial communication. When the GPS receiver is connected to the image capturing terminal in which the place is previously registered and the image capturing terminal is operated, the point-to-point wireless communication between the GPS receiver and the image capturing terminal is automatically performed. After the point-to-point wireless communication is established, the GPS receiver transmits GPS information (position information) to the image capturing terminal, and the image capturing terminal adds the GPS information to the image.

However, when the GPS receiver and the image taking terminal perform the wireless communication, the image capturing terminal receives the GPS information via real-time communication. Thus, if the image capturing terminal fails to receive the GPS information, no GPS information is added to the image. Furthermore, the GPS receiver for receiving the GPS information is expensive. Irrespective of whether the image taking terminal takes an image or not, since the GPS receiver continuously stores position information on a regular basis, an unnecessary operation is repeatedly performed.

### SUMMARY

The exemplary embodiments provide a system and method for adding position information to an image by storing an inherent identifier in regard to the image and position information of a position at which the image is captured, and recording the position information using the stored information in an image file, whenever necessary, when a digital image processing device captures the image.

According to an exemplary embodiment, there is provided a system for inserting position information to an image, the system comprising: a digital image processing device for capturing an image and generating and storing a plurality of image files; and a global positioning system (GPS) device for computing a position based on data received from a GPS satellite, wherein, when a predetermined image capture signal is received from the digital image processing device, the GPS device comprises a GPS information storage unit for storing inherent information of a file of the captured image and position information of a position at which the image is captured; and wherein the digital image processing device comprises a GPS information input controller for inserting position information of the position at which the image is captured into the image file.

When the inherent information of the file of the captured image and the position information of the position at which the image is captured are received from the GPS device, the GPS information input controller may search for an image file corresponding to the inherent information from among the image files stored in the digital image processing device, and insert the position information into the found image file.

The digital image processing device may transmit the predetermined image capture signal to the GPS device in a unilateral direction.

The predetermined image capture signal may be a simple signal indicating that an image is captured, wherein the inherent information of the file of the captured image that is stored in the GPS information storage unit is a time when the GPS device receives the simple signal.

The predetermined image capture signal may include at least one of a name of the file of the captured image and a time when the image is captured, wherein the inherent information of the file of the captured image that is stored in the GPS information storage unit is the name of the file of the captured image or the time when the image is captured.

According to another aspect of the present invention, there is provided a system for inserting position information to an image, the system comprising: a digital image processing device for capturing an image and generating and storing a plurality of image files; and a GPS device for computing a position based on data received from a GPS satellite, wherein, when a predetermined image capture signal is received from the digital image processing device, the GPS device comprises a GPS information storage unit for storing inherent information of a file of the captured image, position information of a position at which the image is captured, and a timestamp of the GPS device at the time when the image is captured; and wherein the digital image processing device comprises a GPS information input controller for inserting position information of the position at which the image is captured into the image file and the timestamp of the GPS device at the time when the image is captured.

When the inherent information of the file of the captured image, the position information of the position at which the image is captured, and the timestamp of the GPS device at the time when the image is captured are received, the GPS information input controller may search for an image file corresponding to the inherent information from among the plurality of image files stored in the digital image processing device and further insert the position information and the timestamp into the found image file.

According to another exemplary embodiment, there is provided a system for inserting position information into an image, the system comprising: a digital image processing device for capturing an image and generating and storing an image file; a GPS device for computing a position based on data received from a GPS satellite; and a personal computer (PC), wherein, when a predetermined image capture signal is received from the digital image processing device, the GPS device comprises a GPS information storage unit for storing, as a log file, inherent information of a file of the captured image and position information of a position at which the image is captured, wherein the PC receives the log file from the GPS device and the image file from the digital image processing device, and, when inherent information of the image file and the inherent information stored in the log file are identical to each other, inserts the position information stored in the log file into the image file having the identical inherent information.

The predetermined image capture signal may be a simple signal indicating that an image is captured, wherein the inherent information of the file of the captured image that is stored in the GPS information storage unit is a time when the GPS device receives the simple signal.

The predetermined image capture signal may include at least one of a name of the file of the captured image and a time when the image is captured, wherein the inherent information of the file of the captured image that is stored in the GPS information storage unit is the name of the file of the captured image or the time when the image is captured.

According to another exemplary embodiment, there is provided a method of operating a system comprising a digital image processing device for capturing an image and generating and storing an image file and a GPS device for receiving position information from a GPS satellite at predetermined time intervals, the method comprising: capturing the image with the digital image processing device; transmitting a predetermined image capture signal from the digital image processing device to the GPS device; storing, as a log file, inherent information of a file of the captured image and position information of a position at which the image is captured; and inserting the position information into the image file.

The predetermined image capture signal may be a simple signal indicating that an image is captured, wherein the inherent information of the file of the captured image that is stored in the GPS information storage unit is a time when the GPS device receives the simple signal.

The predetermined image capture signal may include at least one of a name of the file of the captured image and a time when the image is captured, wherein the inherent information of the file of the captured image that is stored in the log file is the name of the file of the captured image or the time when the image is photographed.

The transmitting of the predetermined image capture signal from the digital image processing device to the GPS device may comprise: determining whether the image is captured in a continuous mode; if the image is captured in the continuous mode, determining whether the image is first captured in the continuous mode; and if the image is first captured in the continuous mode, transmitting the predetermined image capture signal from the digital image processing device to the GPS device.

The inserting of the position information into the image file may comprise: determining whether the log file stores inherent information of the file of the captured image that is identical to inherent information of the image file; and if the log file stores the identical inherent information, inserting the position information stored in the log file into the image file.

The inserting of the position information into the image file may further comprise: if the log file does not store the identical inherent information, determining whether a photographing interval between the image file and image files before and/or after the image file is within a predetermined period of time; and if the photographing interval between the image file and the before and/or after image files is within the predetermined period of time, inserting the identical position information to the before and/or after image files into the image file.

The inserting of the position information into the image file may further comprise: if the photographing interval between the image file and the before and/or after image files is beyond the predetermined period of time, inserting optional position information into the image file according to a user's selection.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 illustrates a system for inserting position information into an image according to an exemplary embodiment;

FIG. 2 is a block diagram of the system illustrated in FIG. 1 according to an exemplary embodiment;

FIG. 3 is a block diagram of the system illustrated in FIG. 1 according to another exemplary embodiment;

FIGS. 4A through 4C illustrate an exchangeable image file format (Exif) structure of a JPEG file into which position information is inserted, according to an exemplary embodiment;

FIG. 5 is a flowchart illustrating a method of operating a system for adding position information to an image according to an exemplary embodiment;

FIG. 6 is a detailed flowchart illustrating an operation of connecting a digital image processing device and a GPS device, as shown in FIG. 5;

FIG. 7 is a detailed flowchart illustrating an operation of transmitting a predetermined image capturing signal from the digital image processing device to the GPS device, as shown in FIG. 5;

FIG. 8 is a detailed flowchart illustrating an operation of storing inherent information of a file of the captured image and position information of a position at which the image is captured in a log file, as shown in FIG. 5;

FIG. 9 is a detailed flowchart illustrating an operation of inserting the position information into an image file, as shown in FIG. 5; and

FIG. 10 illustrates a time at which an image capture signal is transmitted from a digital image processing device to a GPS device, a success or failure of transmission of the image capture signal, and log files generated at the time when the image capture signal is successfully transmitted, according to an exemplary embodiment.

### DETAILED DESCRIPTION

Hereinafter, exemplary embodiments will be described in detail with reference to the attached drawings. In the drawings, like reference numerals refer to the like elements throughout.

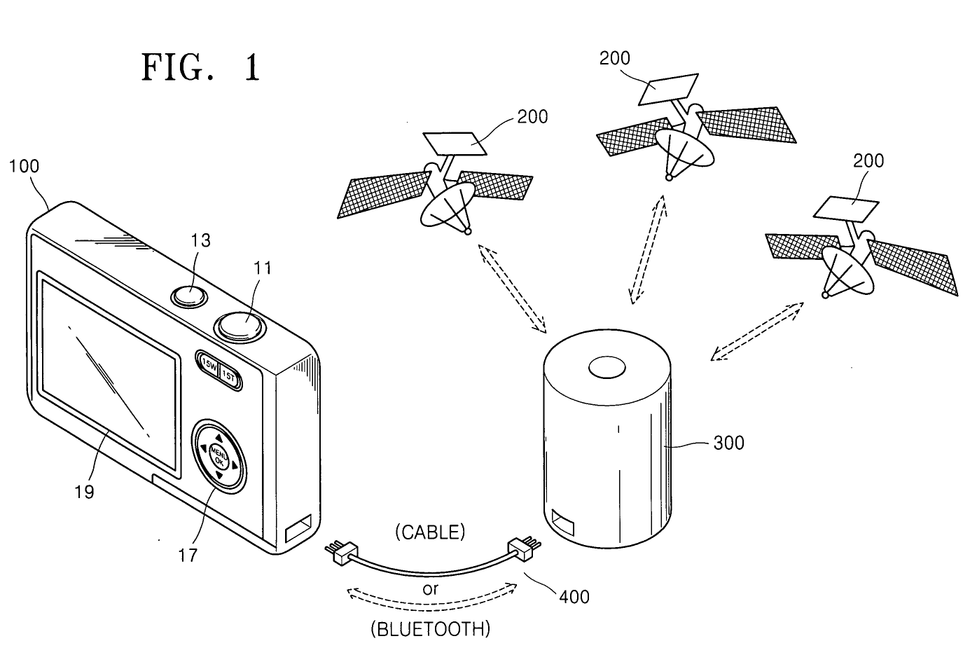

FIG. 1 illustrates a system for inserting position information into an image according to an embodiment. The system comprises a digital image processing device 100, a global positioning system (GPS) satellite 200, a GPS device 300, and a communication mechanism 400. The digital image processing device 100 may comprise the GPS device 300 internally or externally. The digital image processing device 100 may comprise the GPS device 300 externally.

The digital image processing device 100 captures an image and generates and stores an image file. As illustrated in FIG. 1, the digital image processing device 100 comprises a shutter-release button 11, a power button 13, a wide angle zoom button 15W, a telephoto zoom button 15T, a function button 17, and a display unit 19.

The shutter-release button 11 is opened and closed to expose a charge-coupled device (CCD) or a film to light for a predetermined period of time and records pictures in the CCD through appropriate exposure by operating an iris (not shown). The power button 13 is used to provide power to the digital image processing device 100 and operate it. The wide angle-zoom button 15W is used to widen the angle of view and the telephoto-zoom button 15T is used to narrow the angle of view. Especially, these two buttons 15W and 15T are used to change the size of a selected exposure area. When the wide angle-zoom button 15W is pressed, the size of the selected exposure area is decreased. When the telephoto-zoom button 15T is pressed, the size of the selected exposure area is increased. The function button 17 includes five buttons including an up button, a down button, a left button, a right button, and a menu/OK button. The function button 17 is used to execute various menus related to the operations of the digital image processing device 100 and may be used as a short-cut key.

The GPS satellite 200 comprises four precise clocks having an error of 1 second per about 160,000 years and provides time information in units of 10⁻⁹ or smaller with an error of 30 m and three-dimensional position information including latitude, longitude, and altitude.

The GPS device 300 receives and stores its position information, i.e., latitude, longitude, altitude, timestamp, speed, and direction from the GPS satellite 200 at predetermined time intervals of, for example, 10 seconds.

In a GPS system comprising the GPS satellite 200 and the GPS device 300, the GPS device 300 receives position measuring radio waves, which are transmitted every second from 24 GPS satellites 200 located at an altitude of about 20,000 km above the earth, and displays its current time and position (including latitude, longitude, altitude, and speed) on a numerical map so that its current position can be recognized in three dimensions.

The communication mechanism 400 connects the digital image processing device 100 with the GPS device 300 via a wired or wireless connection so that data communication can be performed between the digital image processing device 100 and the GPS device 300. When the wired connection is used, the communication mechanism 400 may be a cable. When the wireless connection is used, the communication mechanism 400 may be Bluetooth. Bluetooth provides near-distance wireless communication between devices without complex cables and a Bluetooth module has a small size of 0.5 square inches and small power consumption of 2.5 mW (based on Class 2). Devices including a Bluetooth module can wirelessly communicate data at a speed of 1 Mbps at a near distance of 10 through 100 m.

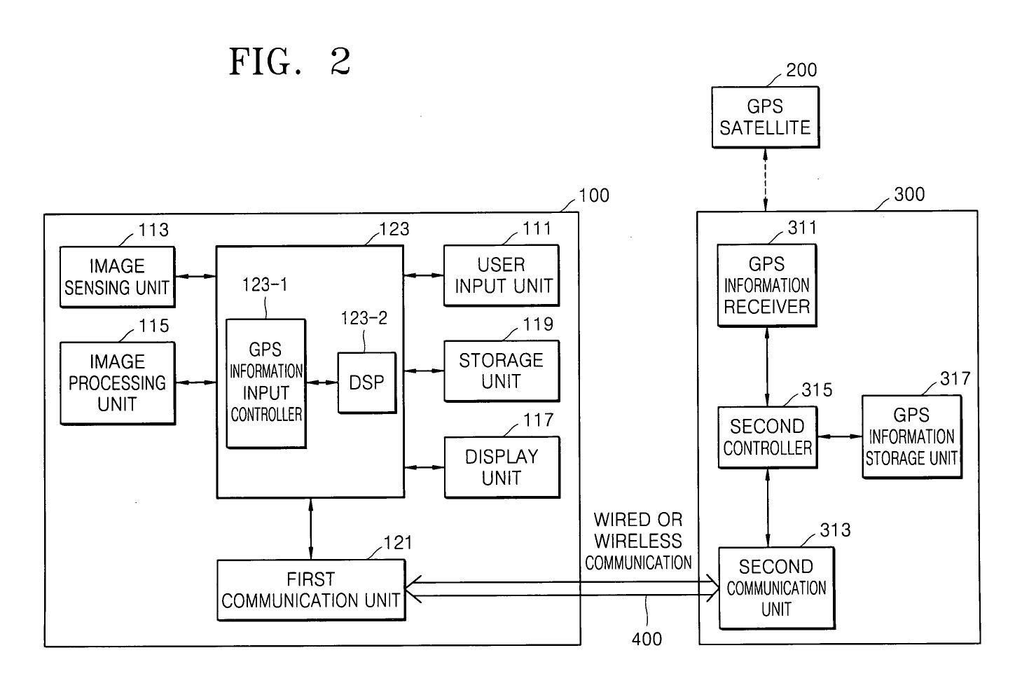

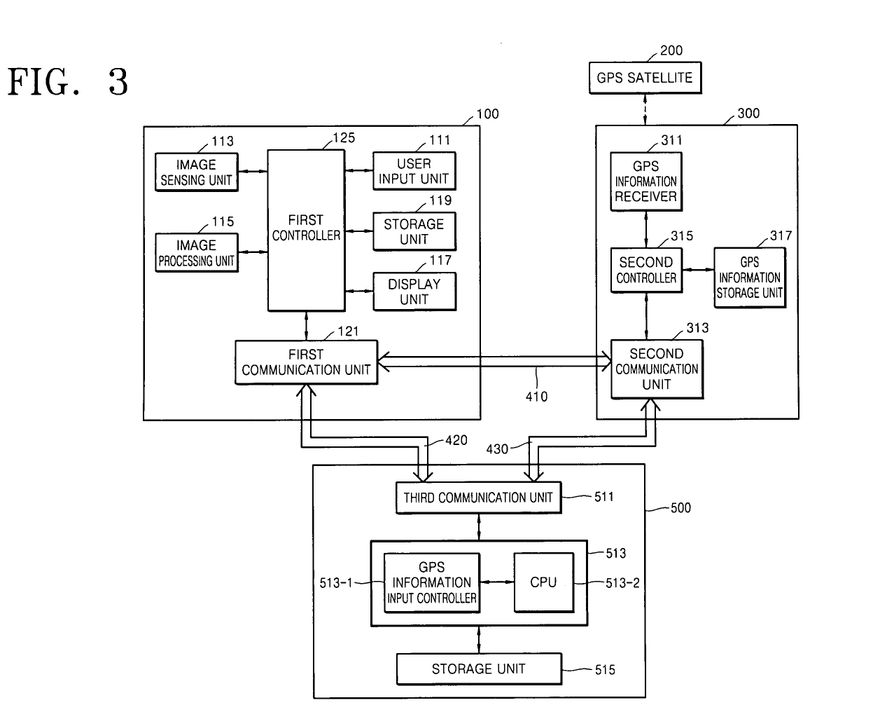

FIG. 2 is a block diagram of the system illustrated in FIG. 1 according to an embodiment of the present invention. FIG. 3 is a block diagram of the system illustrated in FIG. 1 according to another exemplary embodiment. Referring to FIG. 2, the digital image processing device 100 inserts position information into an image file using a log file received from the GPS device 300. Referring to FIG. 3, a PC 500 inserts position information into an image file using the image file received from the digital image processing device 100 and the log file received from the GPS device 300.

Referring to FIG. 2, the digital image processing device 100 comprises a user input unit 111, an image sensing unit 113, an image processing unit 115, a display unit 117 (corresponding to the display unit 19 in FIG. 1), a storage unit 119, a first communication unit 121, and a first controller 123. The first controller 123 comprises a GPS information input controller 123-1 and a digital signal processor (DSP) 123-2.

Referring to FIG. 1, the user input unit 111 comprises the shutter-release button 11 which is opened and closed to expose a CCD or a film to light for a predetermined period of time, the power button 13 which turns on of off the digital image processing device 100, the wide angle-zoom button 15W which widens the angle of view, the telephoto-zoom button 15T which narrows the angle of view, and the function button 17 which is used to execute various menus related to the operations of the digital image processing device 100.

The image sensing unit 113 comprises the shutter-release button 11 and, although not shown, a lens unit, an iris, a CCD, and an analog-to-digital converter (ADC). The shutter-release button 11 adjusts the quality of exposure light by using the iris. The lens unit receives light from an external light source and processes an image. Here, the iris is opened or closed to adjust the quality of incident light. The degree of opening/closing of the iris is controlled by the first controller 125. The CCD accumulates light input through the lens unit 19 and outputs an image, which is sensed by the lens unit according to the quality of the accumulated light, in synchronization with a vertical sync signal. The image acquisition of the digital image processing device 100 is carried out by the CCD which converts light, which is reflected from a subject, into an electrical signal. The ADC converts an analog image signal output from the CCD into a digital signal.

The image processing unit 115 processes a digitized image signal so that it can be displayed. Elements used in the CCD are sensitive to changes in temperature and thus generates a dark current according to a changing temperature, which results in a black level in the image signal. The image processing unit 115 removes the black level caused by the dark current. In addition, the image processing unit 115 performs gamma correction. Human sight reacts non-linearly to brightness according to Weber's law. When the brightness of light is linearly recorded with a limited bit depth, posterization occurs. Accordingly, to provide a highest picture quality at a given bit depth, it may be preferable to perform coding using a non-linear function. The operation of coding information so as to agree with the non-linearity of human sight is referred to as gamma correction. The image processing unit 115 performs gamma correction on an input image signal by using a gamma curve. For example, the image processing unit 115 corrects the input luminance level of a 12-bit image signal into the luminance level of an 8-bit image signal.

The image processing unit 115 also performs color filter array (CFA) interpolation, by which a Bayer pattern including an RGRG line and a GBGB line of gamma corrected data is interpolated by an RGB line. When the CFA interpolation of the image processing unit 115 is performed, a G channel is first restored by using pixels that have only an R or B channel value and then empty values are filled in an order of B and R or R and B channels. As such, three R, G, and B channels are restored.

The image processing unit 115 converts interpolated RGB signals into YUV signals, performs edge compensation to sharpen an image by filtering a Y signal by using a high pass filter and color correction to correct color values of U and V signals using a standard color coordinate system, and removes noise.

Thereafter, the image processing unit 115 performs compression and signal processing on the noise-removed Y, U, and V signals so as to generate a Joint Photographic Experts Group (JPEG) file as an image file. The JPEG file is displayed by the display unit 117 and stored in the first storage unit 119. All operations of the image processing unit 115 are controlled by the DSP 123-2 of the first controller 125.

The first communication unit 121 is controlled by the DSP 123-2 to perform data communication through the communication mechanism 400 via a wireless or wired connection. The first communication unit 121 is controlled by the DSP 123-2 to transmit a predetermined image capture signal to the GPS device 300 when an image is captured and to receive a log file storing inherent information of a file of the image and position information of a position at which the image is captured from the GPS device 300.

The first controller 123 comprises the GPS information input controller 123-1 and the DSP 123-2 in order to input the position information. In the present embodiment, the DSP 123-2 of the first controller 123 provides a variety of menus for inputting the position information, and controls a series of operations relating to the input of the position information according to a user's selection of a menu.

In order to input the position information, when the digital image processing device 100 is used to capture an image, the digital image processing device 100 transmits a predetermined image capture signal indicating that the image is captured to the GPS device 300 through the first communication unit 121. If the GPS device 300 receives the predetermined image capture signal, the predetermined image capture signal, which is inherent information of a file of the image, is paired with the position information of a position at which the image is captured, and is stored in a log file.

The predetermined image capture signal may be two types of signals.

As a first type of the predetermined image capture signal, the predetermined image capture signal may be a simple signal indicating that the image is captured. That is, a signal indicating that the image is simply captured is transferred to the GPS device 300 from the digital image processing device 100. The GPS device 300 establishes the time when the GPS device 300 receives the image capture signal indicating that the image is captured as the inherent information of the file of the image. The inherent information and the position information of a position at which the image is captured are stored in the log file. An example of the log file storing the inherent information (the time when the image capture signal is received by the GPS device 300) and the position information of a position at which the image is captured is as follows.

inherent information 1 (YYYY/MM/DD::hh:mm:ss 1), position information 1 (longitude 1, latitude 1)

inherent information 2 (YYYY/MM/DD::hh:mm:ss 2), position information 2 (longitude 2, latitude 2)

inherent information 3 (YYYY/MM/DD::hh:mm:ss 3), position information 3 (longitude 3, latitude 3)

On exemplary embodiment, the predetermined image capture signal is transmitted in a unilateral direction. That is, the GPS device 300 and the digital image processing device 100 do not exchange a request and a response via a bidirectional signal transmission but instead, the digital image processing device 100 transmits the predetermined image capture signal to the GPS device 300 via a unilateral signal transmission.

The GPS information input controller 123-1 receives the log file from the GPS device 300, searches for an image file having inherent information corresponding to the inherent information stored in the log file, from among image files stored in the storage unit 119, and inserts the position information stored in the log file into the image file.

In more detail, as described above, the inherent information of the file of the image and the position information of the position at which the image is captured are stored in the log file. Therefore, when the GPS information input controller 123-1 inserts the position information stored in the log file into the image file, the log file is transmitted from the GPS device 300 to the digital image processing device 100.

The GPS information input controller 123-1 determines whether the log file includes inherent information identical to the inherent information of the image file. For example, if “YYYY/MM/DD::hh:mm:ss 1” is the time when an image file is generated in the digital image processing device 100, the GPS information input controller 123-1 opens the log file and searches for inherent information “YYYY/MM/DD::hh:mm:ss 1” from among the inherent information of the log file. If the log file includes the inherent information “YYYY/MM/DD::hh:mm:ss 1”, the GPS information input controller 123-1 inserts position information (e.g., longitude 1, latitude 1) stored in the log file into the image file. Meanwhile, if the log file does not include the inherent information “YYYY/MM/DD::hh:mm:ss 1”, the GPS information input controller 123-1 inserts position information of an image file before or after the image file.

As a second type of the predetermined image capture signal, the predetermined image capture signal may be an inherent unique value of an image file, such as a file name or capture time of the file of the captured image. In more detail, if an image is captured and an image file is generated, inherent information of the image file, such as a name or capture time of the image file, is transferred to the GPS device 300 from the digital image processing apparatus 100. The GPS device 300 stores the inherent information of the image file and position information of a position at which the image is captured in a log file.

At this time, the log file may store a timestamp of the time when the image is captured. In more detail, since the GPS device 300 receives and stores position information thereof, time, and the like, from a GPS satellite 200 at regular intervals, the GPS device 300 always has an accurate timestamp. Meanwhile, the digital image processing device 100 has a possibility of storing an inaccurate timestamp due to an erroneous operation or a failure in the operation. Therefore, the GPS device 300 may store inherent information of the received image file and position information of a position at which the image is captured in the log file together with the timestamp of the time when the image is captured. An example of the log file storing the inherent information (e.g., a file name), the position information of a position at which the image is captured, and the timestamp of the time when the image is captured is as follows.

inherent information 1 (NV10001.JPG), position information I (longitude 1, latitude 1), timestamp 1 (YYYY/MM/DD::hh:mm:ss 1)

inherent information 2 (NV10002.JPG), position information 2 (longitude 2, latitude 2), timestamp 2 (YYYY/MM/DD::hh:mm:ss 2)

inherent information 3 (NV10003.JPG), position information 3 (longitude 3, latitude 3), timestamp 3 (YYYY/MM/DD::hh:mm:ss 3)

The GPS information input controller 123-1 receives the log file from the GPS device 300, searches for an image file having inherent information corresponding to the inherent information stored in the log file, from among image files stored in the storage unit 119, and inserts the position information stored in the log file into the image file.

In more detail, as described above, the inherent information of the file of the image and the position information of the position at which the image is captured are stored in the log file. Therefore, when the GPS information input controller 123-1 inserts the position information stored in the log file into the image file, the log file is transmitted from the GPS device 300 to the digital image processing device 100.

The GPS information input controller 123-1 determines whether the log file includes inherent information identical to the inherent information of the image file. For example, if an image file “NV10001.JPG” is stored in the digital image processing device 100, the GPS information input controller 123-1 opens the log file and searches for inherent information “NV10001.JPG” from among the inherent information of the log file. If the log file includes the inherent information “NV10001.JPG”, the GPS information input controller 123-1 inserts position information (e.g., longitude 1, latitude 1) stored in the log file into the image file “NV10001.JPG”. Meanwhile, if the log file does not include the inherent information “NV10001.JPG”, the GPS information input controller 123-1 inserts position information of an image file before or after the image file “NV10001.JPG”.

When the timestamp of the time when the image is captured is stored in the log file, the GPS information input controller 123-1 may further insert the timestamp (e.g., time 1) into the image file. Two methods may be used to insert the timestamp into the image file. First, the first controller 123 compares a file generation time of the image file with the timestamp stored in the log file, and, if the file generation time and the timestamp are different from each other, the first controller 123 replaces the file generation time with the timestamp. Second, the first controller 123 may replace the file generation time of the image file with the timestamp stored in the log file without comparing them. Therefore, the image file can have an accurate file generation time.

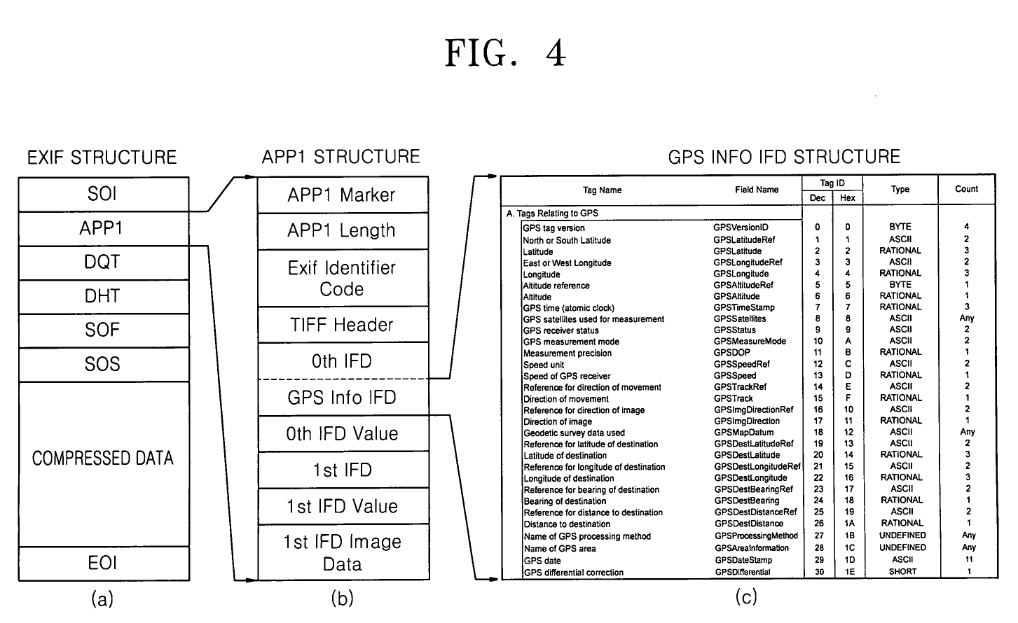

FIGS. 4A through 4C illustrate an exchangeable image file format (Exif) structure of a JPEG file into which position information is inserted, according to an exemplary embodiment. FIG. 4A illustrates the Exif structure of the JPEG file generated by the image processing unit 115 under the control of the DSP 123-2. In an application marker segment1 (APP1) of the Exif file, a date on which compressed image data was captured, additional information such as a product name, or thumbnail information is recorded. FIG. 4B also illustrates the structure of the APP1. In the APP1, a 0th image file directory (IFD) field includes a GPS Info IFD field. The first DSP 123-2 stores position information stored in a log file in the GPS info IFD field. FIG. 4C also illustrates the structure of the GPS Info IFD field. The GPS Info IFD field includes information on a GPS version, a GPS latitude, a GPS longitude, a GPS altitude, a GPS speed, a GPS timestamp, and satellite, which is stored in the log file.

As illustrated in FIG. 2, the GPS device 300 includes a GPS information receiver 311, a second storage unit 313, a second controller 315, and a GPS information storage unit 317.

When the GPS device 300 is turned on, the GPS information receiver 311 is controlled by the second controller 315 to receive time information on the GPS device 300 and the latitude, the longitude, the altitude, the direction information of the GPS device 300 as position information thereof, from the GPS satellite at predetermined time intervals of, for example, 10 seconds, and update state information thereof.

The second communication unit 313 is controlled by the second controller 315 to perform data communication through the communication mechanism 400 via a wireless or wired connection. The second communication unit 313 is controlled by the second controller 315 to receive a predetermined image capture signal from the digital image processing device 100 when the digital image processing device 100 captures an image, and to transmit a log file storing inherent information of a file of the captured image and position information of where the image is captured to the digital image processing device 100.

The GPS information storage unit 317 stores the log files storing the inherent information of the file of the captured image and the position information of where the image is captured. The position information includes the latitude, the longitude, the altitude, the timestamp, speed, and the direction information as described above. The constitution of the log file is the same as described above.

Therefore, it is possible to insert position information into an image file all the time, thereby enhancing convenience for a user.

The present embodiment shown in FIG. 3 is similar to the previous embodiment shown in FIG. 2 except that the PC 500 comprises a GPS information input controller to insert position information into an image file.

Referring to FIG. 3, the digital image processing device 100 comprises a user input unit 111, an image sensing unit 113, an image processing unit 115, a display unit 117 (corresponding to the display unit 19 in FIG. 1), a storage unit 119, a first communication unit 121, and a first controller 125. The digital image processing device 100 of the present embodiment is similar to that of FIG. 2 except that the first controller 125 does not comprise a GPS information input controller, and thus a detailed description thereof will not be repeated here.

The GPS device 300 comprises a GPS information receiving unit 311, a second communication unit 313, a second controller 315, and a GPS information storage unit 317. The GPS device 300 of the present embodiment is similar to that of FIG. 2 and thus a detailed description thereof will not be repeated here.

In the previous embodiment shown in FIG. 2, the digital image processing device 100 comprises the GPS information input controller 123-1 for inserting position information into an image file. Meanwhile, the PC 500 includes a GPS information input controller 513-1 for inserting position information into an image file by using the image file received from the digital image processing device 100 and a log file received from the GPS device 300.

The PC 500 comprises a third communication unit 511, a third controller 513, and a storage unit 515.

The third communication unit 513 performs wireless or wired data communication through communication members 420 and 430 under the control of a central processing unit (CPU) 513-2. That is, the third communication unit 513 receives the image file from the digital image processing device 100 and the log file from the GPS device 300 under the control of the CPU 513-2.

In order to input the position information, the third controller 513 comprises the GPS information input controller 513-1 and the CPU 513-2. In the present embodiment, the CPU 513-2 of the third controller 513 provides a variety of menus for inputting the position information and controls a series of operations relating to the input of the position information according to a user's selection of a menu.

When the GPS information input controller 513-1 receives image files from the digital image processing device 100 and a log file from the GPS device 300, the GPS information input controller 513-1 searches for an image file having inherent information corresponding to inherent information stored in the log file, from among the image files received from the digital image processing device 100 and inserts position information stored in the log file into the found image file.

In more detail, as described above, inherent information of a file of a captured image and position information of a position at which the image is captured are stored in the log file. Therefore, when the GPS information input controller 513-1 inserts the position information into the image file, the log file is transmitted from the GPS device 300 to the PC 500 and is stored in the storage unit 515. The image files stored in the digital image processing device 100 are transmitted to the PC 500 and are stored in the storage unit 515.

The GPS information input controller 513-1 determines whether the log file includes inherent information identical to the inherent information of the image file. For example, if an image file “NV10001.JPG” is stored in the storage unit 515, the GPS information input controller 513-1 opens the log file and searches for inherent information “NV10001.JPG” from among the inherent information of the log file. If the log file includes the inherent information “NV10001.JPG”, the GPS information input controller 513-1 inserts position information (e.g., longitude 1, latitude 1) stored in the log file into the image file “NV10001.JPG”. Meanwhile, if the log file does not include the inherent information “NV10001.JPG”, the GPS information input controller 513-1 inserts position information of an image file before or after the image file “NV10001.JPG”. When a timestamp of the time when the image is captured is stored in the log file, the GPS information input controller 513-1 may further insert the timestamp (e.g., time 1) into the image file.

Therefore, in the present embodiment, the GPS information input controller 513-1 can always insert position information into an image file, thereby enhancing convenience for a user. Furthermore, the PC 500 can be used to input GPS information, thereby enhancing convenience of operation for a user.

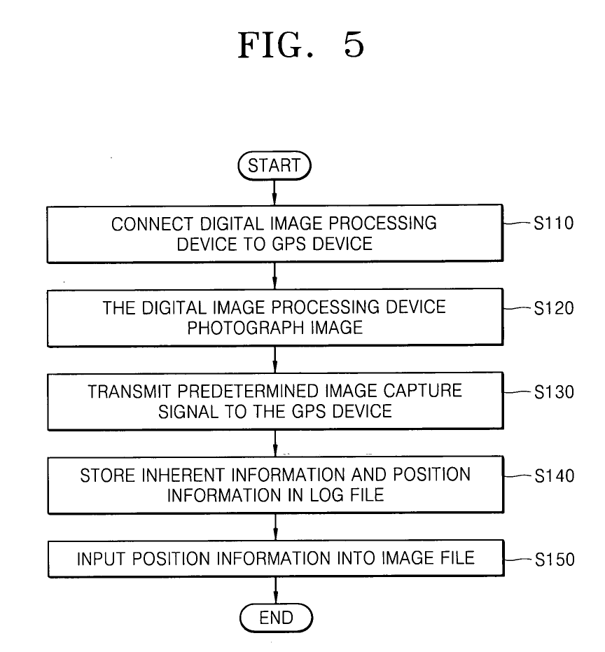

A method of operating a system for inserting position information into an image according to exemplary embodiments will now be described with reference to FIGS. 5 through 9.

FIG. 5 is a flowchart illustrating a method of operating a system for inserting position information into an image according to an exemplary embodiment. Referring to FIG. 5, the method comprises operations of connecting the digital image processing device 100 and the GPS device 300 (S110); capturing an image by using the digital image processing device 100 (S120); transmitting a predetermined image capture signal from the digital image processing device 100 to the GPS device 300 (S130); storing inherent information of a file of the captured image and position information of a position at which the image is captured in a log file (S140); and inserting the position information into the image file (S150).

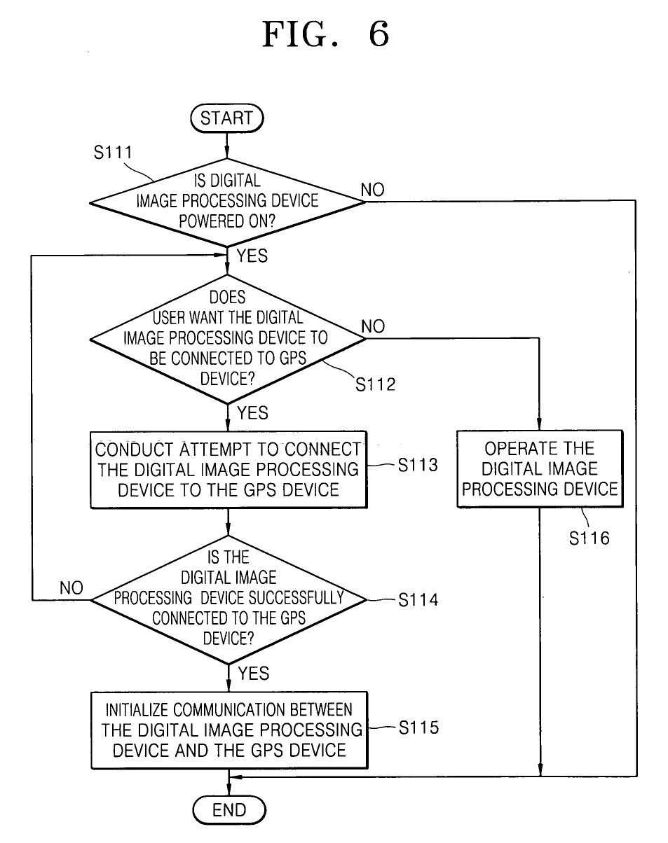

FIG. 6 is a detailed flowchart illustrating operation S110 shown in FIG. 5. Referring to FIG. 6, in operation S110 in which the digital image processing device 100 is connected to the GPS device 300, it is determined whether the digital image processing device 100 is powered on (S111); it is determined whether a user wants the digital image processing device 100 to be connected to the GPS device 300 (S112); if it is determined that the user wants the digital image processing device 100 to be connected to the GPS device 300, an attempt is made to connect the digital image processing device 100 to the GPS device 300 (S113); it is determined whether the digital image processing device 100 is successfully connected to the GPS device 300 (S114); and, if it is determined that the digital image processing device 100 is successfully connected to the GPS device 300, communication between the digital image processing device 100 and the GPS device 300 is initialized (S115).

In operation S112, if it is determined that the user does not want the digital image processing device 100 to be connected to the GPS device 300, only the digital image processing device 100 is operated (S116).

In operation S114, if it is determined that the digital image processing device 100 is not successfully connected to the GPS device 300, operation S112 is repeated.

The communication member 400 connects the digital image processing device 100 to the GPS device 300 via a wired or wireless connection so that data communication can be performed between the digital image processing device 100 and the GPS device 300. When a wired connection is used, the communication member 400 may be a cable. When a wireless connection is used, the communication member 400 may be Bluetooth. Bluetooth provides near-distance wireless communication between devices without complex cables and a Bluetooth module has a small size of 0.5 square inches and small power consumption of 2.5 mW (based on Class 2). Devices including a Bluetooth module can wirelessly communicate data at a speed of 1 Mbps at a near distance of 10 through 100 m.

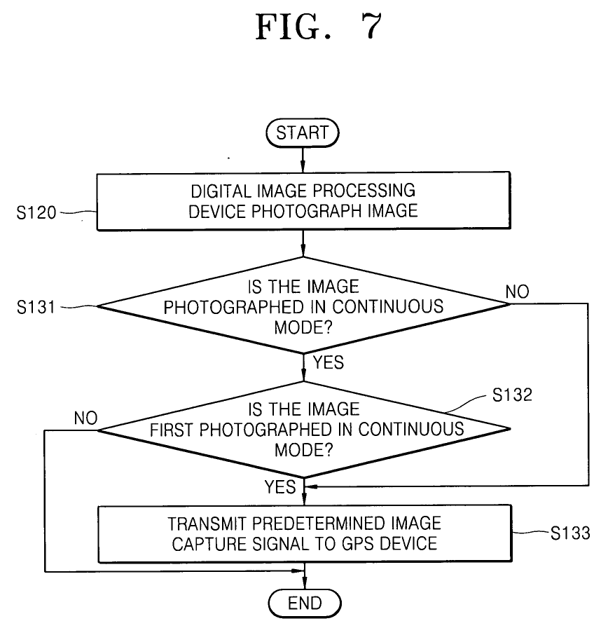

FIG. 7 is a detailed flowchart illustrating operation S130 shown in FIG. 5. Referring to FIG. 7, the DSP 123-2 of the first controller 123 of the digital image processing device 100 determines whether the image has been captured in a continuous mode (S131). If the image has been captured in the continuous mode, the DSP 123-2 determines whether the image is first captured in the continuous mode (S132). If the image has not been captured in the continuous mode, or the image is first captured in the continuous mode, the digital image processing device 100 transmits a predetermined image capture signal to the GPS device 300 (S133). Meanwhile, if the image is not first captured in the continuous mode, the digital image processing device 100 does not transmit the predetermined image capture signal to the GPS device 300.

Since a plurality of images are captured within a short period of time in the continuous mode, the images have substantially the same GPS information. In more detail, if the same position information is stored in a plurality of image files, no unnecessary transaction occurs between the digital image processing device 100 and the GPS device 300, thereby reducing overload of the DSP 123-2. In order to avoid disrupting a photographing function as much as possible, in operation Si 33, the digital image processing device 100 may transmit the predetermined image capture signal to the GPS device 300 only when the image is first captured in the continuous mode. According to the constitution described above, it is possible to prevent unnecessary transactions and memory consumption.

On the other hand, the predetermined image capture signal that is transmitted from the digital image processing device 100 to the GPS device 300 may be a simple signal indicating that an image is captured. That is, a signal indicating that the image is simply captured may be transmitted from the digital image processing device 100 to the GPS device 300.

Alternatively, the predetermined image capture signal that is transmitted from the digital image processing device 100 to the GPS device 300 may be an inherent unique value of an image file, such as a name of the image file or a time when the image is captured. That is, when an image is captured and an image file is generated, inherent information of the image file, such as the name of the image file or the time when the image is captured, may be transmitted from the digital image processing device 100 to the GPS device 300.

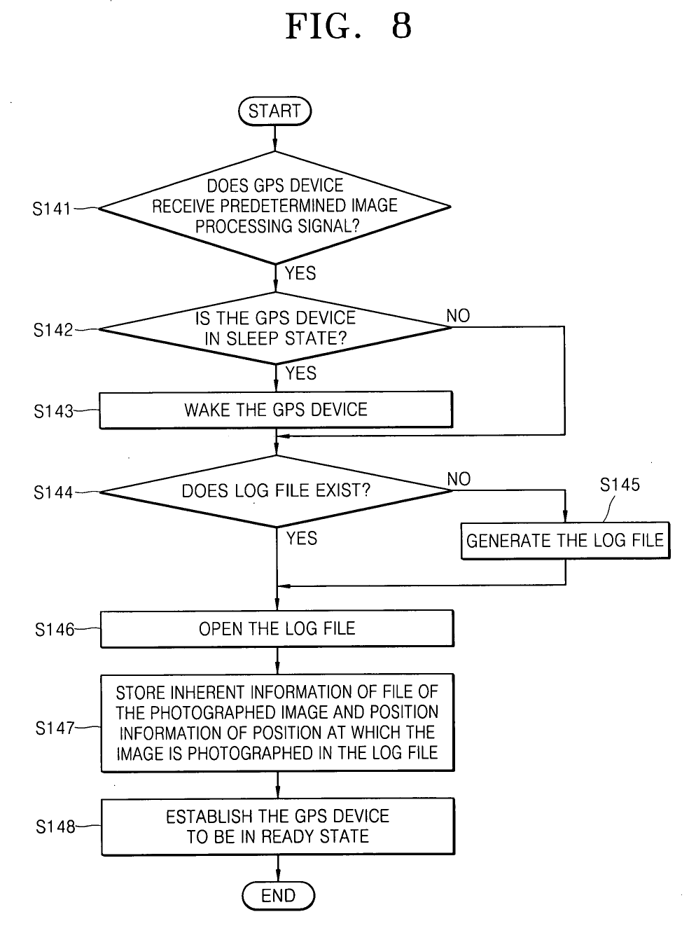

FIG. 8 is a detailed flowchart illustrating operation S140 shown in FIG. 5. Referring to FIG. 8, in operation S140 in which the inherent information of the file of the captured image and the position information of the position at which the image is captured are stored in the log file, if the GPS device 300 receives the predetermined image capture signal from the digital image processing device 100 (S141), the second controller 315 of the GPS device 300 determines whether the GPS device 300 is in a sleep state (S142), and, if the GPS device 300 is in the sleep state, wakes the GPS device 300 (S143). The controller 315 determines whether a log file exists (S144), and, if the log file does not exist, generates the log file (S145). The second controller 315 opens the generated log file or the previously existing log file (S146), stores the inherent information of the file of the captured image and the position information of the position at which the image is captured in the generated log file or the previously existing log file (S147), and establishes that the GPS device 300 is in a ready state (S148).

If the predetermined image capture signal is a simple signal indicating that an image is captured, the GPS device 300 establishes the time the image capture signal is received in the GPS device 300 as inherent information of the file of the captured image. The GPS device 300 stores the inherent information and position information of a position at which the image is captured in the log file as follows.

Inherent information 1 (YYYY/MM/DD::hh:mm:ss 1), position information 1 (longitude 1, latitude 1)

Alternatively, if the predetermined image capture signal is an inherent unique value of an image file, such as a name of the file of the captured image or a time when the image is captured, the GPS device 300 stores the inherent information and position information of a position at which the image is captured in the log file as follows. The GPS device 300 may store the inherent information, the position information of the position at which the image is captured, and a timestamp of the time when the image is captured in the log file as follows.

Inherent information 1 (NV10001.JPG), position information 1 (longitude 1, latitude 1), timestamp 1 (YYYY/MM/DD::hh:mm:ss 1)

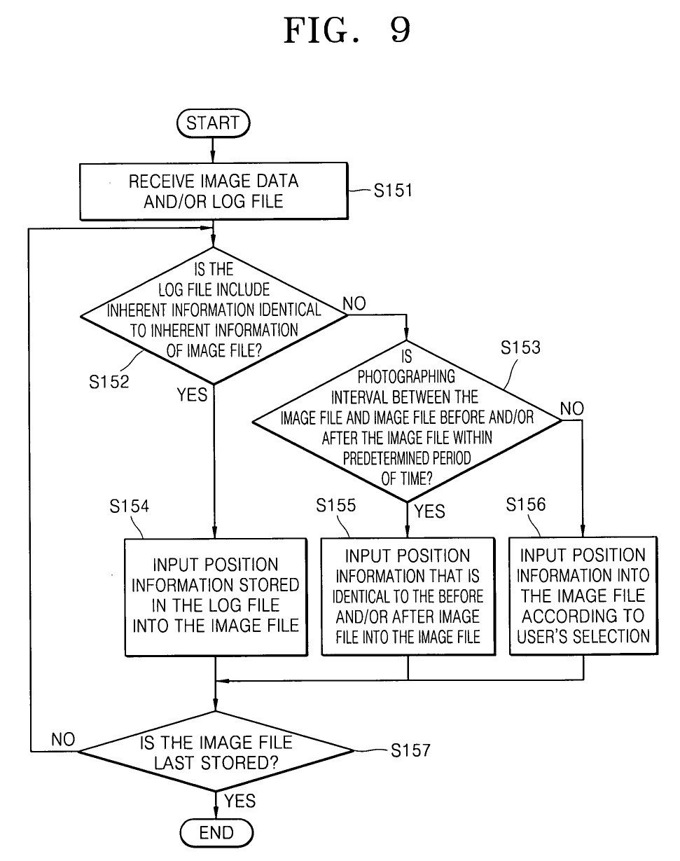

FIG. 9 is a detailed flowchart illustrating operation S150 shown in FIG. 5. Referring to FIG. 9, in operation S150 in which position information is inserted into an image file, the image file and/or a log file is received (S151).

In more detail, in the embodiment shown in FIG. 2, the digital image processing device 10 includes the GPS information input controller 123-1 for inserting position information into an image file. In this case, a log file stored in the GPS information storage unit 317 of the GPS device 300 is transmitted to the digital image processing device 100.

Meanwhile, in the embodiment shown in FIG. 3, the PC 500 includes the GPS information input controller 513-1 for inserting position information into an image file by using an image file received from the digital image processing device 100 and a log file received from the GPS device 300. In this case, the log file stored in the GPS information storage unit 317 of the GPS device 300 and the image file stored in the storage unit 119 of the digital image processing device 100 are transmitted to the PC 500.

It is determined whether the log file includes inherent information identical to inherent information of the image file (S152). If the log file includes inherent information identical to inherent information of the image file, the inherent information and position information that are stored in the log file are inserted into the image file (S154).

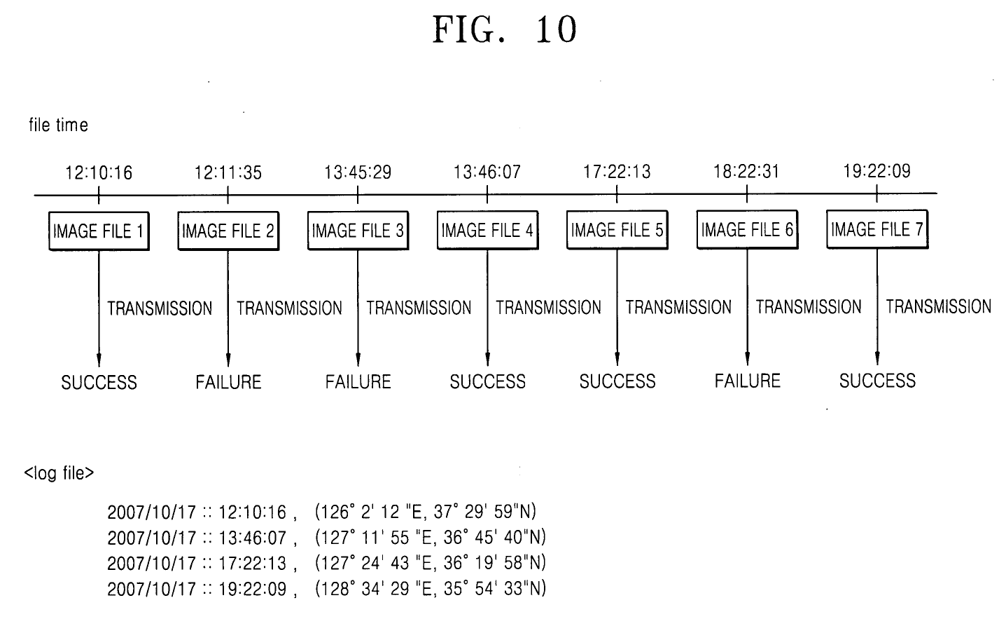

FIG. 10 illustrates a time when an image capture signal is transmitted from a digital image processing device to a GPS device, a success or failure in transmission of the image capture signal, and log files generated at the time when the image capture signal is successfully transmitted, according to an exemplary embodiment. Referring to FIG. 10, a “file time” is the time when an image file is generated in the storage unit 119 of the digital image processing device 100, i.e., a capture time of the image file. A “success/failure” indicates whether a predetermined image capture file is successfully transmitted from the digital image processing device 100 to the GPS device 300. When image files 1,4, 5, and 7 are captured, the predetermined image capture file is successfully transmitted. When image files 2, 3, and 6 are captured, the predetermined image capture file is not successfully transmitted. A “log file” is generated when the predetermined image capture file is successfully transmitted. The log file stores times when the image files 1, 4, 5, and 7 are received and position information of positions at which the image files 1, 4, 5, and 7 are received.

For example, the image file 1 that is stored in the storage unit 119 of the digital image processing device 100 or the storage unit 515 of the PC 500 has a file time of Oct. 17, 2007 at 12:10:16. The GPS information input controllers 123-1 and 513-1 open the log file and search for inherent information “2007/10/17:: 12:10:16” from among inherent information stored in the log file. Since the log file includes the inherent information “2007/10/17::12:10:16”, in operation S154, position information (126° 2′ 12″ E, 37° 29′ 59″ N) stored in the log file along with the inherent information “2007/10/17::12:10:16” is inserted into the image file.

Meanwhile, in operation 152, if the log file includes inherent information identical to inherent information of the image file, it is determined whether a photographing interval between the image file and an image file before and/or after the image file is within a predetermined period of time (S153). If the photographing interval between the image file and the before and/or after the image file is within the predetermined period of time, position information that is identical to the before and/or after the image file is inserted into the image file (S1 55).

For example, the image file 2 that is stored in the storage unit 119 of the digital image processing device 100 or the storage unit 515 of the PC 500 has a file time of Oct. 17, 2007 at 12:11:35. The GPS information input controllers 123-1 and 513-1 open the log file and search for inherent information “2007/10/17::12:11:35” among inherent information stored in the log file. Because the log file does not include the inherent information “2007/10/17::12:11:35”, in operation S153, the GPS information input controllers 123-1 and 513-1 determines whether a photographing interval between the image file and the image file 1 before the image file and the image file 4 after the image file is within a predetermined period of time (e.g., four minutes). Because the photographing interval between the image file 2 and the image file 1 is within one minute, in operation S155, position information 126° 2′ 12″ E, 37° 29′ 59″ N that is identical to the image file 1 is inserted into the image file 2. In the same manner, position information 127° 11′ 55″ E, 36° 45′ 40″ N that is identical to the image file 4 is inserted into the image file 3.

Meanwhile, if the photographing interval between the image file and the before and/or after image file is beyond the predetermined period of time, optional position information is inserted into the image file according to a user's selection (S156).

For example, the image file 6 that is stored in the storage unit 119 of the digital image processing device 100 or the storage unit 515 of the PC 500 has a file time of Oct. 17, 2007 at 18:22:31. The GPS information input controllers 123-1 and 513-1 open the log file and search for inherent information “2007/10/17::18:22:31” from among inherent information stored in the log file. Since the log file does not include the inherent information “2007/10/17::18:22:31”, in operation S153, the GPS information input controllers 123-1 and 513-1 determines whether a photographing interval between the image file 6 and the image file 5 before the image file and between the image file 6 and the image file 7 after the image file is within a predetermined period of time (e.g., five minutes). Since the photographing interval between the image file 6 and the image file 5 and between the image file 6 and the image file 7 is more than five minutes, in operation S156, optional position information (of the image file 5 or the image file 7) is inserted into the image file according to a user's selection.

When a timestamp of the time when the image is captured is stored in the log file, the timestamp may be further inserted into the image file.

It is determined whether the image file is last stored in the storage unit 119 of the digital image processing device 100 or the storage unit 515 of the PC 500 (S157). If the image file is not last stored in either the storage unit 119 of the digital image processing device 100 or the storage unit 515 of the PC 500, operations S152 through S156 are repeated.

According to the constitution described above, although there is no communication between the digital image processing device 100 and the GPS device 300 when an image is captured, it is possible to input position information of a closest position at which the image is captured.

As described above, according to the present invention, when a digital image processing apparatus captures an image, it stores an identifier of the image and position information of where the image is captured, and records the position information into an image file using the stored information whenever it is deemed necessary, thereby inserting the position information into the image file all the time and increasing convenience for a user.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for inserting position information to an image, the system comprising:
a digital image processing device for capturing an image, generating and storing a plurality of image files; and
a global positioning system (GPS) device for computing a position based on data received from a GPS satellite,
wherein, the GPS device comprises a GPS information storage unit for storing inherent information of an image file and position information of a position at which the image is captured, when a predetermined image capture signal is received from the digital image processing device; and
wherein the digital image processing device comprises a GPS information input controller for inserting position information of the position at which the image is captured into the image file.

2. The system of claim 1, wherein, when the inherent information of the image file and the position information of the position at which the image is captured are received from the GPS device, the GPS information input controller searches for an image file corresponding to the inherent information from among the image files stored in the digital image processing device, and inserts the position information into the found image file.

3. The system of claim 1, wherein the digital image processing device transmits the predetermined image capture signal to the GPS device in a unilateral direction.

4. The system of claim 1, wherein the predetermined image capture signal is a signal indicating that an image is captured,
wherein the inherent information of the image file that is stored in the GPS information storage unit is a time when the GPS device receives the signal.

5. The system of claim 1, wherein the predetermined image capture signal comprises at least one of a name of the image file and a time when the image is captured,
wherein the inherent information of the image file that is stored in the GPS information storage unit is the name of the image file or the time when the image is captured.

6. A system for inserting position information to an image, the system comprising:
a digital image processing device for capturing an image, generating and storing a plurality of image files; and
a GPS device for computing a position based on data received from a GPS satellite,
wherein the GPS device comprises a GPS information storage unit;
wherein, when a predetermined image capture signal is received from the digital image processing device, the GPS information storage unit stores image inherent information of an image file, position information of a position at which the image is captured, and a timestamp of the GPS device at the time when the image is captured; and
wherein the digital image processing device comprises a GPS information input controller for inserting position information of the position at which the image is captured into the image file and the timestamp of the GPS device at the time when the image is captured.

7. The system of claim 6, wherein, when the inherent information of the image file, the position information of the position at which the image is captured, and the timestamp of the GPS device at the time when the image is captured are received, the GPS information input controller searches for an image file corresponding to the inherent information from among the plurality of image files stored in the digital image processing device and further inserts the position information and the timestamp into the found image file.

8. A system for inserting position information into an image, the system comprising:
a digital image processing device for capturing an image, generating and storing an image file;
a GPS device for computing a position based on data received from a GPS satellite; and
a personal computer (PC),
wherein, the GPS device comprises a GPS information storage unit for storing, as a log file, inherent information of an image file and position information of a position at which the image is captured, when a predetermined image capture signal is received from the digital image processing device;
wherein the PC receives the log file from the GPS device and the image file from the digital image processing device, and, when the inherent information of the image file and the inherent information stored in the log file are identical to each other, inserts the position information stored in the log file into the image file having the identical inherent information.

9. The system of claim 8, wherein the predetermined image capture signal is a signal indicating that an image is captured,
wherein the inherent information of the file of the captured image that is stored in the GPS information storage unit is a time when the GPS device receives the signal.

10. The system of claim 8, wherein the predetermined image capture signal comprises at least one of a name of the image file and a time when the image is captured,
wherein the inherent information of the image file that is stored in the GPS information storage unit is the name of the image file or the time when the image is captured.

11. A method of operating a system comprising a digital image processing device for capturing an image, generating and storing an image file; and a GPS device for receiving position information from a GPS satellite at predetermined time intervals, the method comprising:
capturing the image;
transmitting a predetermined image capture signal from the digital image processing device to the GPS device;
storing, as a log file, inherent information of an image file and position information of a position at which the image is captured; and
inserting the position information into the image file.

12. The method of claim 11, wherein the predetermined image capture signal is a signal indicating that an image is captured,
wherein the inherent information of the image file that is stored in the GPS information storage unit is a time when the GPS device receives the signal.

13. The method of claim 11, wherein the predetermined image capture signal comprises at least one of a name of the image file and a time when the image is captured,
wherein the inherent information of the image file that is stored in the log file is the name of the image file or the time when the image is photographed.

14. The method of claim 11, wherein the transmitting of the predetermined image capture signal from the digital image processing device to the GPS device comprises:
determining whether the image is captured in a continuous mode;
if the image is captured in the continuous mode, determining whether the image is first captured in the continuous mode; and
if the image is first captured in the continuous mode, transmitting the predetermined image capture signal from the digital image processing device to the GPS device.

15. The method of claim 11, wherein the inserting of the position information into the image file comprises:
determining whether the inherent information of the image file stored in the log file is identical to inherent information of the image file; and
if the inherent information stored in the log file is identical to the inherent information of the image file, inserting the position information stored in the log file into the image file.

16. The method of claim 15, wherein the inserting of the position information into the image file further comprises:
if the inherent information stored in the log file is not identical to the inherent information of the image file, determining whether a photographing interval between the image file and image files before and/or after the image file is within a predetermined period of time; and
if the photographing interval between the image file and the before and/or after image files is within the predetermined period of time, inserting the position information of the before and/or after image files into the image file.

17. The method of claim 16, wherein the inserting of the position information into the image file further comprises:
if the photographing interval between the image file and at least one of the before and after image files exceeds the predetermined period of time, inserting optional position information into the image file according to a user's selection.
